(19) United States
(12) Patent Application Publication
(10) Pub. No.: US 2024/0144396 A1
(43) Pub. Date: May 2, 2024

(54) CONCENTRATE GRADE OPTIMIZATION ENGINE IN A MATERIAL PROCESSING SYSTEM

(71) Applicant: The Boston Consulting Group, Inc., Boston, MA (US)

(72) Inventors: Rohin Wood, Boston, MA (US); Ric Zong-Yang Porteous, Sydney (AU); Artem Vladimirov, New South Wales (AU); Malcolm James Walsh, Melbourne (AU); Julian Edwin Lovett Cooper, New South Wales (AU)

(21) Appl. No.: 17/977,296

(22) Filed: Oct. 31, 2022

(51) Int. Cl. G06Q 30/02; G06Q 50/04

(52) U.S. Cl. CPC G06Q 30/0206; G06Q 50/04

(57) ABSTRACT

Methods, systems, and computer storage media for providing a concentrate grade recommendation using a concentrate grade optimization engine in a material processing engine of a material processing system. The concentrate grade recommendation refers to a quantified value for concentrate grade that corresponds to an economic value for ore of a mining process. In operation, input data comprising material processing planning data and economic data associated with a recovery process are accessed. The input data is analyzed using a grade recovery relationship machine learning model. The grade recovery relationship machine learning model is trained on historical material processing data features associated with concentrate grade and recovery of the material recovery process. The historical data includes data on produced concentrate (e.g., achieved grades and corresponding recovery). Based on analyzing the input data, a concentrate grade that corresponds to an economic value is generated. The concentrate grade and the economic value are communicated.

### BACKGROUND

Many companies rely on material processing systems to produce goods from raw materials. Material processing systems implement manufacturing processes that include steps through which raw materials are transformed into a final product. For example, a manufacturing process can be a mining process for extracting valuable minerals or other geological materials from ores. A material processing system can operate based on mining process configurations that can include control schemes with several control variables that support eliminating gangue particles or other impurities to produce a concentrate. For example, raw ore can be ground finely in various comminution operations and gangue is removed, thus concentrating the metal component.

Conventionally, material processing systems are not configured with a computing infrastructure and logic to provide concentrate grade (e.g., a concentrate grade recommendation) that correspond to an economic value of an ore. For example, conventional material processing systems—that support mining processes—may rely on historical material processing data analysis that compute correlation relationships (e.g., concentrate grade relative to recovery) that may result in incorrect conclusions (e.g., increasing concentrate grade is predicted to increase recovery). Moreover, some material processing systems do not perform any historical data analysis and merely mine ores without the additional insights that can be determined from metallurgical relationships—in the mining process—that impact concentrate grade, recovery, and the economic value of the ore. As such, a more comprehensive material processing system—having an alternative basis for providing material processing system data analytics and operations—can improve processing techniques provided using material processing systems.

### SUMMARY

Various aspects of the technology described herein are generally directed to systems, methods, and computer storage media, for among other things, providing a concentrate grade recommendation using a concentrate grade optimization engine in a material processing engine of a material processing system. The concentrate grade recommendation can refer to a quantified value for concentrate grade that corresponds to an economic value of an ore. The recommendation is determined based on estimating how much different concentrate grades impact recovery, where estimating an impact of concentrate grade to recovery is based on material processing data analytics associated with modeling separate flows of valuable metals in an ore.

In operation, a plurality of flow models separately model the flow of valuable materials (e.g., copper, pyrite, gold) in a flotation circuit based on incoming ore characteristics (e.g., head grades) and mass pull decisions. For each of the plurality of flow models, a functional relationship (i.e., a functional form) that corresponds to metallurgical relationships associated with the corresponding flow model is determined. An estimated shape of a functional relationship curve (i.e., selectivity curves) can be estimated using historical data and machine learning techniques (e.g., Bayesian machine learning techniques). The plurality of flow models and their estimated functional forms can be used to generate a causal mathematical model that corresponds to historical observation data. The causal mathematical model can be used to compute concentrate grades that adhere to expected metallurgical relationships. In this way, the concentrate grade optimization engine can access the causal mathematical model, input materials of a mining process, flow model input data and economic data to generate concentrate grade. The economic data can include revenue from valuable metals and associated costs. Advantageously, a selected concentrate grade recommendation can correspond to a maximum economic value of the ore.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary material processing system with a material processing engine, in which embodiments described herein may be employed;

FIGS. 1C-1H are schematics associated with an exemplary material processing system with a material processing engine, in which embodiments described herein may be employed;

FIG. 2A is a block diagram of an exemplary material processing system with a material processing engine, in which embodiments described herein may be employed;

FIG. 2B is a schematic associated with an exemplary material processing system with a material processing engine, in which embodiments described herein may be employed;

FIG. 3 is a flow diagram showing an exemplary method for implementing a material processing system with a material processing engine, in accordance with embodiments described herein;

FIG. 4 is a flow diagram showing an exemplary method for implementing a material processing system with a material processing engine, in accordance with embodiments described herein;

FIG. 5 is a flow diagram showing an exemplary method for implementing a material processing system with a material processing engine, in accordance with embodiments described herein;

FIG. 6 provides a block diagram of an exemplary distributed computing environment suitable for use in implementing aspects of the technology described herein; and

FIG. 7 is a block diagram of an exemplary computing environment suitable for use in implementing aspects of the technology described herein.

### DETAILED DESCRIPTION OF THE INVENTION

### Overview

By way of background, a material processing system can be associated with an industrial environment that manages continuous flow of a material as the material is being processed. The material processing system can refer to a complex physical manufacturing system or mining processing system that supports continuous flow of a particular material. During the continuous material flow, the material processing system can extract a particular material property from the material. For example, the material processing system can include components that support extracting a valuable mineral from ores that are in a continuous flow process in the material processing system. The material processing system can also include on-premise gathering of data. Data can be gathered—using sensors and computing components where computing components process the data—to calibrate and improve the material processing system. For example, sensors can measure different types of variables—including temperature, vibrations, acidity—where the data is gathered and stored in a database.

Conventionally, material processing systems may use traditional optimization techniques for generating optimal controls; however traditional techniques rely on machine learning models that have several limitations in the material processing context. For example, a standard machine learning model merely correlates data for control variables to an optimization target (e.g., an outcome, material or product being produced). In particular, machine learning models may identify situations of reverse causality and make erroneous recommendations for optimal controls that result in the opposite intended outcome. Standard machine learning models can lead to wrong conclusions and wrong recommendations when sensing data that is continuous in time. In this way, standard machine learning models do not include computations to avoid strong auto-correlation between factors, as such, they have difficulty identifying situations of reverse causation in material processing—especially in continuous flow processes.

Accordingly, standard machine learning models—that support mining processes—may rely on historical material processing data analysis that computes correlation relationships (e.g., concentrate grade relative to recovery) that may result in incorrect conclusions (e.g., increasing concentrate grade is predicted to increase recovery). Moreover, some material processing systems do not perform any historical data analysis and merely mine ores without the additional insights that can be determined from metallurgical relationships—in the mining process—that impact concentrate grade, recovery, and the economic value of the ore (e.g., every mine has a profitability curve with an optimum concentrate grade that results in the best economic value accounting for customer contract terms and resulting recovery). As such, a more comprehensive material processing system—having an alternative basis for providing material processing system data analytics and operations—can improve processing techniques provided using material processing systems.

Embodiments of the present disclosure are directed to providing a concentrate grade recommendation using a concentrate grade optimization engine in material processing engine of a material processing system. The concentrate grade recommendation can refer to a quantified value for concentrate grade that corresponds to an economic value of an ore. The concentrate grade recommendation is determined based on estimating how much different concentrate grades impact recovery, where estimating an impact of concentrate grade to recovery is based on material processing data analytics associated with modeling separate flows of valuable metals in an ore.

Operationally, a material processing engine can support estimating selectivity curves (i.e., equations) using machine learning techniques (e.g., Bayesian modeling techniques) for a relationship between concentrate grade and recovery, such that, concentrate grades that correspond to an economic values of an ore can be determined. In this way, the material processing engine can determine an optimal concentrate grade based on estimating an impact of the concentrate grade on recovery in a material process. The material processing engine can accurately model recovery and concentrate grade trade-offs to yield better estimates of the recovery that can be achieved for a particular concentrate grade, and the estimate data is analyzed in combination with economic data to support determining optimum concentrate grade for a mining process.

Advantageously, after establishing a concentrate grade relative to recovery relationship, the material processing engine implements long-term mining plans (i.e., how much estimated to be mined and ore of which concentrate grade that is expected to be retrieved) and expected contract terms to find an optimal grade that maximizes overall economic value for a mine. Economic value includes revenue from metals and accounts for marginal costs (e.g., metal deductions, transportation, treatment and refinement charges, impurities charges).

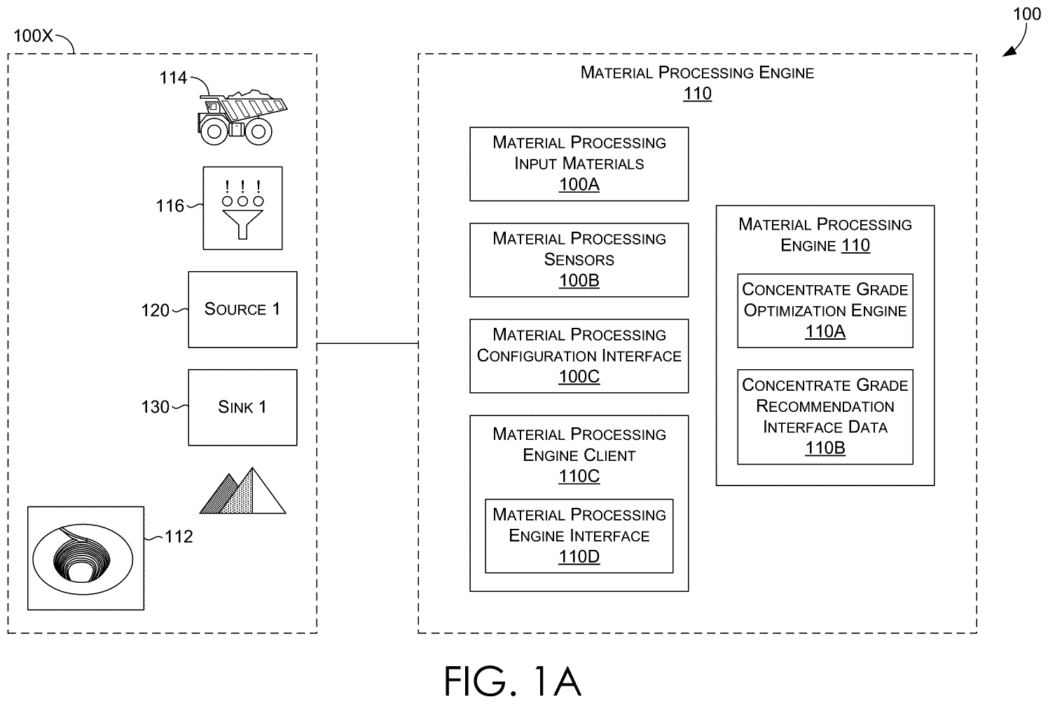

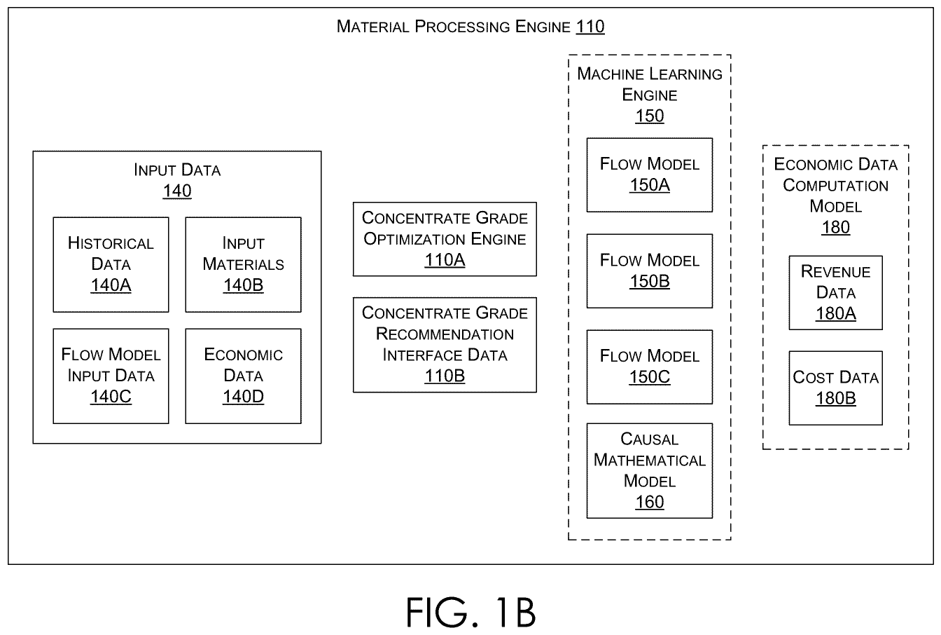

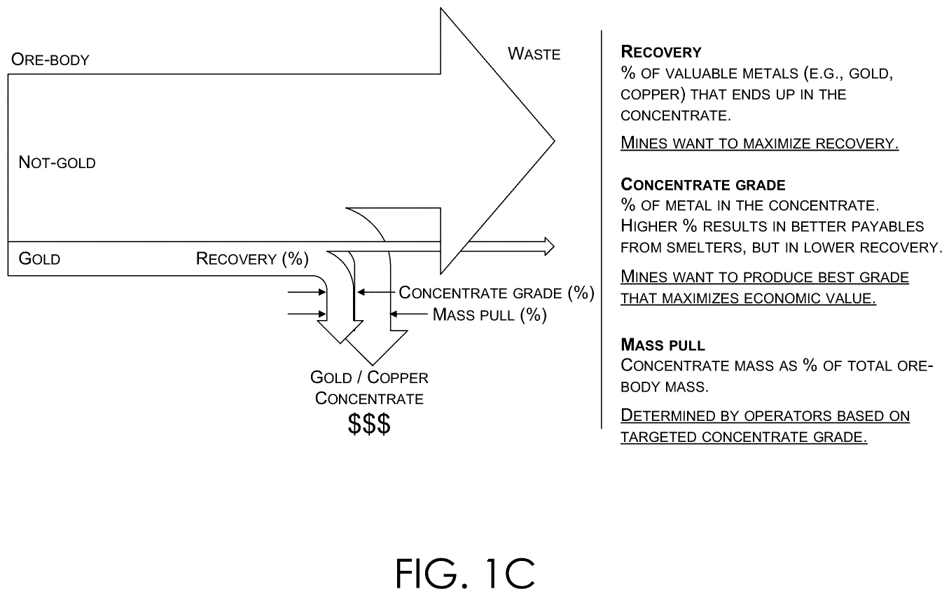

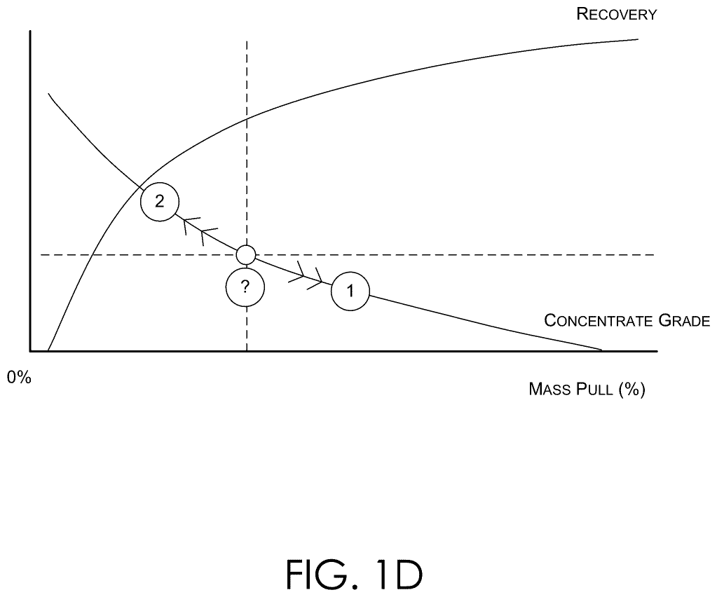

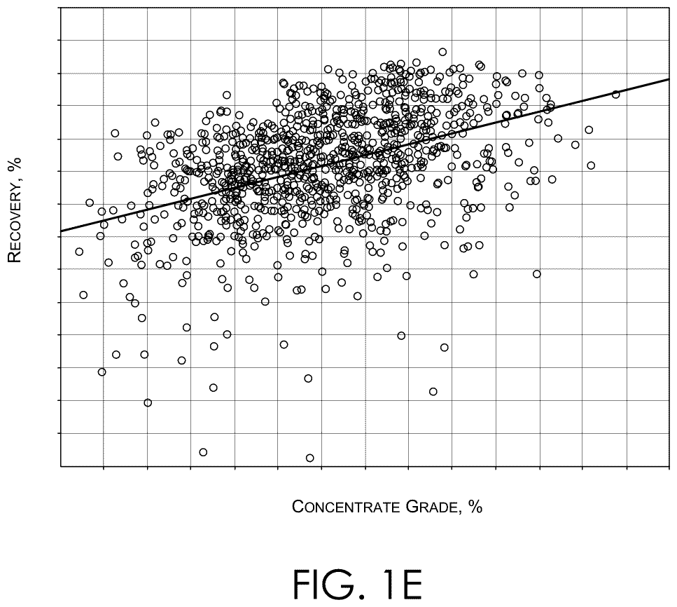

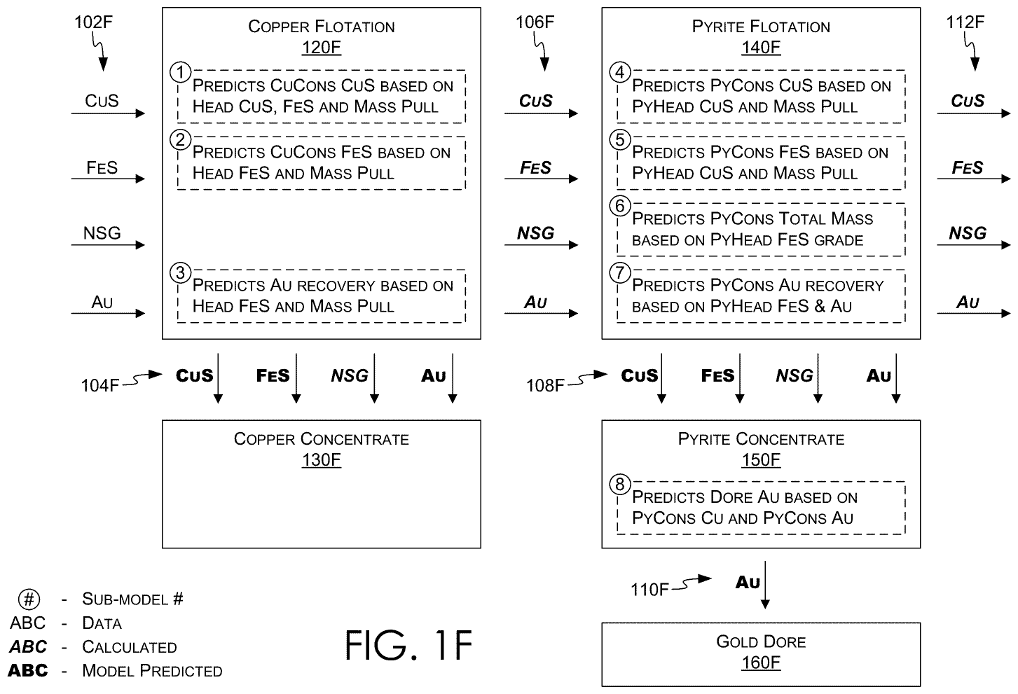

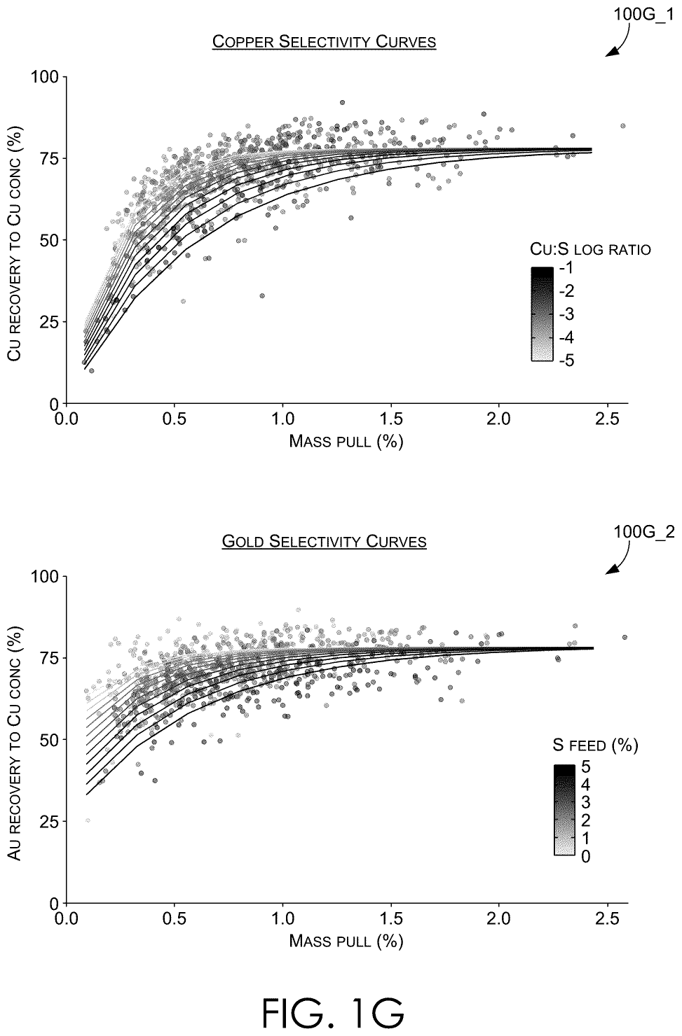

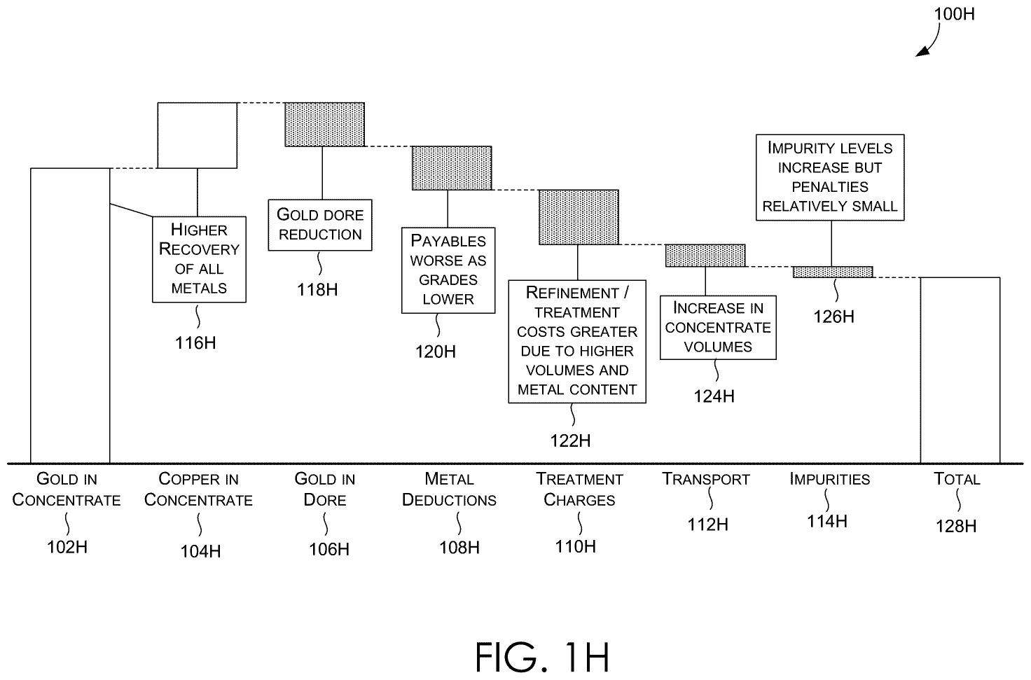

Aspects of the technical solution can be described by way of examples and with reference to FIGS. 1A, 1B, and 1C-1H. FIG. 1A illustrates a material processing system 100 (e.g., mining process system 100X having pit 112, truck 114, crusher 116, source 1 120, sink 1 130). The material processing system 100 further includes material processing input materials 100A, material processing sensors 100B, material processing configuration interface 100C, material processing engine client 110C and material processing engine interface 110D. The material processing system 100 also includes material processing engine 110 having a concentrate grade optimization engine 110A and concentrate grade recommendation interface data 110B. The material processing system 100 corresponds to the material processing system 100 U.S. application Ser. No. 17/666,320 entitled “OVERFLOW MANAGEMENT CONFIGURATION IN A MATERAIL PROCESSING SYSTEM,” which is incorporated herein in its entirety.

The material processing system 100 provides an operating environment for processing a material (e.g., ore from the plurality of sources to the plurality of sinks). The material processing system 100, for example, can support a mining operation for the extraction of valuable minerals or other geological materials from a pit (e.g., pit 112) transported for processing using trucks (e.g., truck 114). For example, ores recovered by mining include metals, coals, oil; however, mining in a wider sense can include extraction of different types of materials. The material processing system 100 includes the material processing engine 110 that supports hardware and software operations in material processing system. For example, the material processing engine 110 can help receive and communicate configurations (e.g., optimal control configuration 110B) and controller signals (e.g., via material processing sensors 100B, material processing configuration interface 110C, and material processing engine client 110C) to support a continuous flow processing of a material. Other variations and combinations of material processing systems and physical manufacturing processes are contemplated with embodiments described herein.

The material processing engine 110 can include the concentrate grade optimization engine 110A associated with concentrate grade recommendation interface data 110B as described herein in more detail. The material processing engine 110 can operate with a material processing engine client 110C that is operationally coupled to a material processing engine interface 110D. The material processing engine client 110C can be a device that provides an interface for assisting (e.g., material processing system operators) with user interactions with the material processing engine 110 and other components of the material processing system 100. The material processing engine client 110C can be part of an optimization platform that supports generating configuration files (e.g., concentration grade recommendations, optimal control configuration, blending flow configuration files, or overflow management configurations files) that can be used as input and controls for components of the material processing system 100. Other variations and combination of material processing engines and materials processing engine clients for generating and implementing configurations associated with components a material processing system are contemplated with embodiment described herein.

With reference to FIG. 1B, FIG. 1B illustrates aspects of the material processing engine 110. FIG. 1B includes input data 140 having historical data 140A, input materials 140B, and economic data 140D; concentrate grade optimization engine 110A, concentrate grade recommendation interface data 110B; machine learning engine 150 having flow models (i.e., flow model 150A, flow model 150B, flow model 150C) and causal mathematical model 160; and economic data computation model 180 having revenue data and cost data.

The historical data can include data associated with produced concentrate, and specifically achieved grades and corresponding recovery. The input materials 140B can include incoming head grades and incoming volumes. Economic data 140D can include contract terms, revenue data, and cost data. Flow model input data can be associated with one or more materials (e.g., valuable metals) of the material recovery process. Flow models can include flow models for copper sulphides (e.g., CuS on FIG. 1F), pyrite sulphides (e.g., FeS on FIG. 1F), NSG (e.g., NSG on FIG. 1F), and gold (e.g., Au on FIG. 1F). Concentrate grade are determined based on economic data 140D (e.g., costs, revenue, profit, etc.) associated with the material processing system 100 (e.g., mining process). Concentrate grade include a quantified value for concentrate grade that corresponds to an economic value of an ore. Economic data 140D can impact the concentrate grade recommended for recovery in a mining process. With a particular concentrate grade identified, there are constraints in the mining process (e.g., constraints on an amount of mass pull from the ore body).

The machine learning engine 150 supports learning from data and improving predictions of concentrate grade recommendations. Operationally, developing a machine learning model for concentrate grade recommendations can be performed via the machine learning engine 150 that supports gathering training data, defining goals and metrics associated with training data features or attributes (e.g., concentrate grade recommendation features). Machine learning techniques can include Bayesian learning techniques, Long Short-Term Memory (LSTM), Random Forest, and Linear Regression to develop forecasting models. For example, a linear regression approach can help predict future values from past values based on identifying underlying trends, so using historical data, additional information—about the specific mine, mining plan, and economic factors—a prediction of a future value can be provided as a recommendation. The machine learning engine can further support training the flow models (i.e., using historical data and algorithms), validation (i.e., flow model parameters and hyper-parameters), and deployment (e.g., integration into production use).

The concentrate grade recommendation interface data can be associated with a concentrate grade that corresponds to an economic value and corresponding concentrate grade recommendation features. For example, values of concentrate grade recommendation features of the concentrate grade recommendation and the economic value can be caused to be presented on an interface (e.g., material processing engine client 110C). A graphical user interface can include a dashboard that provides a visual display of data (e.g., concentrate grade recommendation interface data 110B). The concentrate grade interface data can specifically include human-readable insights (e.g., plain-text or text-based graphical user interface elements) associated with the flow models and concentrate grade recommendation features.

With reference to FIG. 1C, the recovery in the material process can refer to a percentage of valuable metals (e.g., gold or copper) recovered from an ore into a concentrate; concentrate grade can refer to a percentage of metal in the concentrate; and mass pull can refer to concentrate mass as a percentage of total ore-body mass. Gold can be gold dore where dore is a term used for rough or unrefined gold produced in the mine's metallurgical plant. In a mining process, the mining process mining components can be configured to ideally maximize recovery, produce the best concentrate grade that maximizes economic value, where the mass pull is determined based on a targeted concentrate grade. By way of example, recovery in a mining process is about trying to throw away waste upstream. An ore body contains metal (e.g., copper and gold)—often in low concentration (e.g., <0.0001% and <1 gram per ton of ore)—however, shipping the ore body (e.g., to a smelter) can be costly, so part of the goal of the mining process is to discard of waste portion (e.g., 99%) of the ore body. The recovered portion is called concentrate grade (e.g., <1%)—sold to smelters—having an amount of mass pull (i.e., % of ore volume pulled into the concentrate—e.g., <1% in the earlier example). Part of an optimization of a mining process to geared towards having as much of metal in the concentrate grade, where there exist a natural kind of trade-off between concentrate grade and recovery.

With reference to FIG. 1D, FIG. 1D illustrates a graphical representation of quantifying a value of changing concentrate grade. As shown, the y-axis indicates a percentage and the x-axis indicate a percentage of mass pull illustrating how much mass ends up in the concentrate. By way of illustration, as more mass is pulled, the amount of recovery increases at the expense of decreasing concentrate grade. This means that as a mine pulls more mass (and produces more concentrate), they increase recovery of valuable metals (and therefore can get paid more) but because they would also produce lower concentrate grade that will worsen their payment terms with the customers (e.g., smelters). As such, the economic data introduces a trade-off, where this trade-off is associated with economic data and concentrate grade.

Operationally, quantifying a value of changing concentrate grade can be based on estimating selectivity curves (i.e., equations) using machine learning techniques (e.g., Bayesian modeling techniques) for a relationship between concentrate grade and recovery, such that, concentrate grades that correspond to an economic values of an ore can be determined. In particular, machine learning models that reflect the selectivity curves can be trained and then economic data can be processed in combination with the relationships between concentrate grade, recovery, and mass pull. In this way, as the concentrate grade of the metal changes, the value of the metal also changes; in other words, if more mass is pulled into the gold, the more gold recovery can be achieved and the more revenue. However, the recovery, mass pull, and concentrate grade are affected by other economic factors including potential revenue from a downstream scavenging process, treatment charges, transport costs, deductions for lower concentrate grades, etc. For example, contract terms can dictate prices of the concentrate where lower concentrate grades get lower payables, or the higher the mass pull the higher the transportation costs.

The material processing engine 110 does not merely use historical data analysis and machine learning techniques to identify positive relationships between concentrate grade and recovery from material processing data—because positive relationships between concentrate grade and recovery can be identified due to other processes in a flotation circuit. For example, with reference to FIG. 1E—that illustrates a graphical representation of recovery percentage (i.e., recovery %) versus concentrate grade percentage (concentrate %)—positive relationships between concentrate grade and recovery can be observed in the data. A naïve data analysis technique would provide counter-intuitive or incorrect results based on the data showing there exists a positive relationship between grade and recovery—which based on induced correlation (e.g., correlation between derived variables that arise from common or shared primary variables in their functional form). In this way, machine learning models may predict that increasing the grade would increase the recovery.

The material processing engine 100 can further determine a causal relationship between the concentrate grade and recovery to avoid incorrect conclusions. The material processing engine 100 can operate to quantify the causal links between concentrate grade and recovery. In particular, the material processing engine further includes a plurality of flow models separately model the flow of valuable materials (e.g., copper, pyrite, gold) in a flotation circuit based on incoming ore characteristics (i.e., head grades) and mass pull decisions. Ore characteristics can refer to mineralogical, chemical, and physical characteristics or ore and mass pull can refer to a percentage of ore volume pulled into a concentrate, where, for example, mass pull decisions are made by operators. For each of the plurality of flow models, a functional relationship (i.e., a functional form) that corresponds to metallurgical relationships associated with the corresponding flow model is determined. An estimated shape of a functional relationship curve (i.e., selectivity curves) can be estimated using historical data and machine learning techniques (e.g., Bayesian machine learning techniques).

With reference to FIG. 1F, FIG. 1F illustrates a schematic associated with exemplary implementation of quantifying causal links between concentrate grade and recovery. FIG. 1F illustrates copper flotation 120F, copper concentrate 130F, pyrite flotation 140F, pyrite concentrate 150F, gold dore 160F, associated with metal flows (e.g., 102F, 104F, 106F, 108F, 110F, and 112F). At a high-level, the plurality of flow models and their estimated functional forms can be used to generate a causal mathematical model that corresponds to historical observation data. The causal mathematical model can be used to compute concentrate grades that adhere to expected metallurgical relationships.

It is contemplated that the causal mathematical model can support predicting a first concentrate grade associated with a first flotation process (e.g., copper flotation) and a second concentrate grade associated with a second flotation process (e.g., pyrite flotation). As illustrated in step 102F a first set of metal flow having corresponding metal flow data is received at copper flotation 120F—such that the metal flow data is used to: (1) predict CuS in copper concentrate (CuCons) based on head CuS, FeS and mass pull, (2) predict FeS in copper concentrate (CuCons) based on head FeS and mass pull; (3) predict Au recovery in copper concentrate based head FeS and mass pull. These predictions at 120F, having corresponding metal flow data, are then used to predict a second set of metal flows at step 104F, which are then used to determine copper concentrate grade 130F.

At step 106, a third set of metal flow having corresponding metal flow data is calculated at pyrite flotation 140F—such that the estimated metal flow is used to: (4) predict pyrite concentrate (PyCons) CuS based on incoming estimated CuS and mass pull; (5) predict pyrite concentrate (PyCons) FeS based on incoming estimated CuS and mass pull; (6) predict pyrite concentrate (PyCons) total mass based on incoming estimated FeS grade; and (7) predict pyrite concentrate (PyCons) Au recovery based on incoming estimated FeS and Au. These predictions at 140F, having corresponding metal flow data, are then used to predict a fourth set of metal flows at step 108F, which are then used (8) to determine gold dore based on pyrite concentrate Cu and Au predictions.

At step 110F, a fifth set of metal flow data having corresponding metal flow data is calculated from the pyrite concentrate 150F—such that the metal flow data is used to determine gold dore 160F. At step 112F, a sixth set of metal data having corresponding metal flow data is calculated from pyrite flotation 140F.

In this way, the concentrate grade optimization engine 110A can access the causal mathematical model, input materials of a mining process, flow model input data and economic data to generate concentrate grade recommendations. The economic data can include revenue from valuable metals associated with cost. Advantageously, a selected concentrate grade recommendation can correspond to a maximum economic value of the ore.

With reference to FIG. 1G, FIG. 1G illustrates a graphs associated with exemplary selectivity curves for recovery relative to mass pull. The selectivity curves are associated with copper in graph 100G_1 and gold in graph 100G_2. As discussed, for each sub-models, a determination can be made for a function form adhering to key metallurgical relationships and then estimated shapes of a relative curve (i.e., selectivity curves) using historical data and Bayesian learning techniques. Graph 100G_1 illustrates copper selectivity curves and Graph 100G_2 illustrates gold selectivity curves. All metal flows sub-models together along with their estimated functional form can support generating a causal mathematical model. The causal mathematical model is explained by historical observation data and key recommendations would adhere to expected metallurgical relationships. For example, an increase in concentrate grade results in decreasing recovery and vice versa.

With reference to FIG. 1H, FIG. 1H illustrates an exemplary comprehensive economics model associated with maximizing an economic values of an ore body. In particular, FIG. 1H includes a breakdown of economic effects, where the breakdown assumes a decrease in concentrate grade. As discussed, mines have profitability curves with optimum concentrate grade that results in the best economic value accounting for customer contract terms and resulting recovery. Economic value includes revenue from metals and accounts for marginal costs (e.g., metal deductions, transportation, treatment and refinement changes, and impurity changes). In this way, how much will be mined and recovery are associated with economic costs.

The breakdown can be associated with the following concentrate grade recommendation features gold in concentrate 102H, copper in concentrate 104H, gold in dore 106H, metal deductions 108H, treatment charges 110H, transport 112H, impurities 114H, higher recovery of all metals 116H, gold dore reduction 118H, payables worse as grades lower 120, refinement/treatment costs greater due to high volumes and metal content 122H, increase in concentrate volumes 124H, and impurity levels increase but penalties relatively small 126H. A total 128H relative to the gold concentrate 102H is illustrated as part of the comprehensive economics model relative to a plurality of concentrate grade recommendation features. Other variations and combination of concentrate grade recommendation features associated with economic value and cost are contemplated with embodiments described herein.

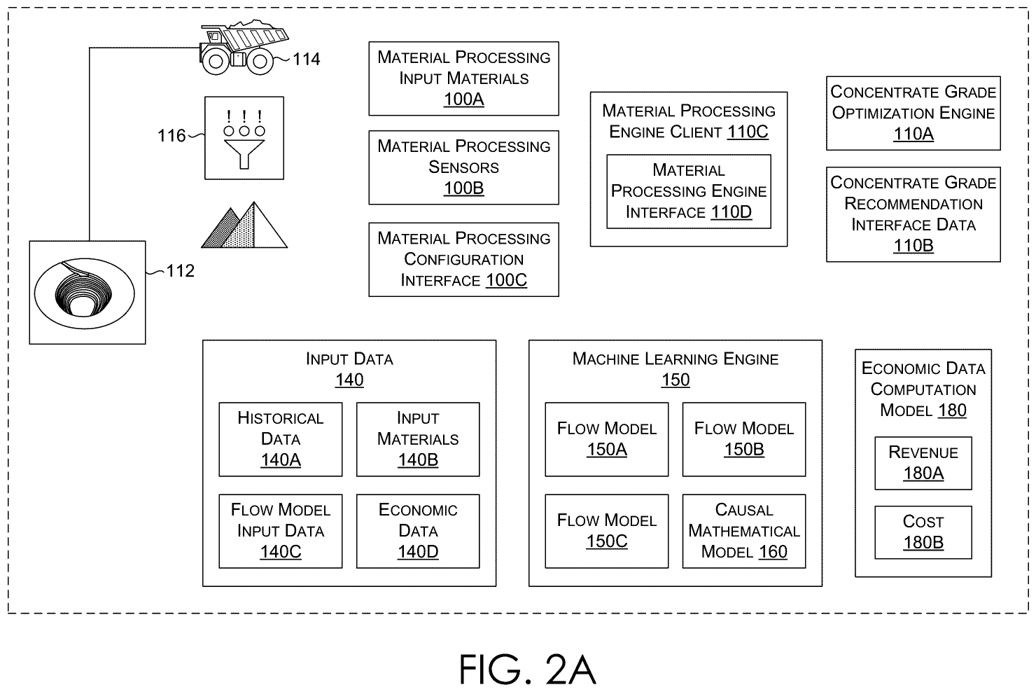

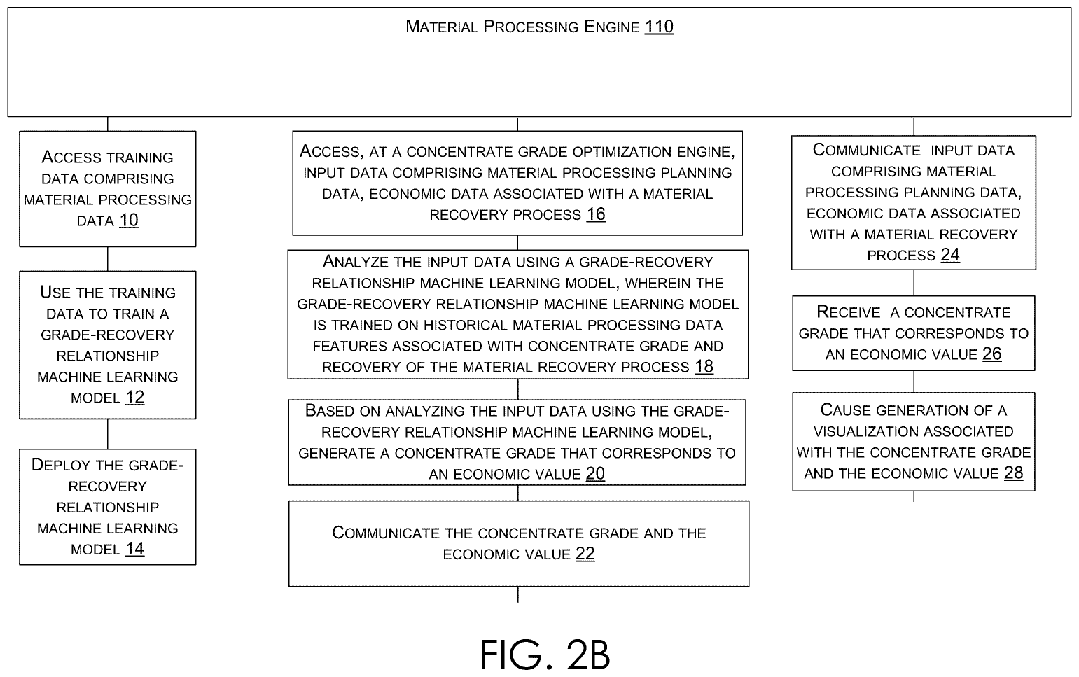

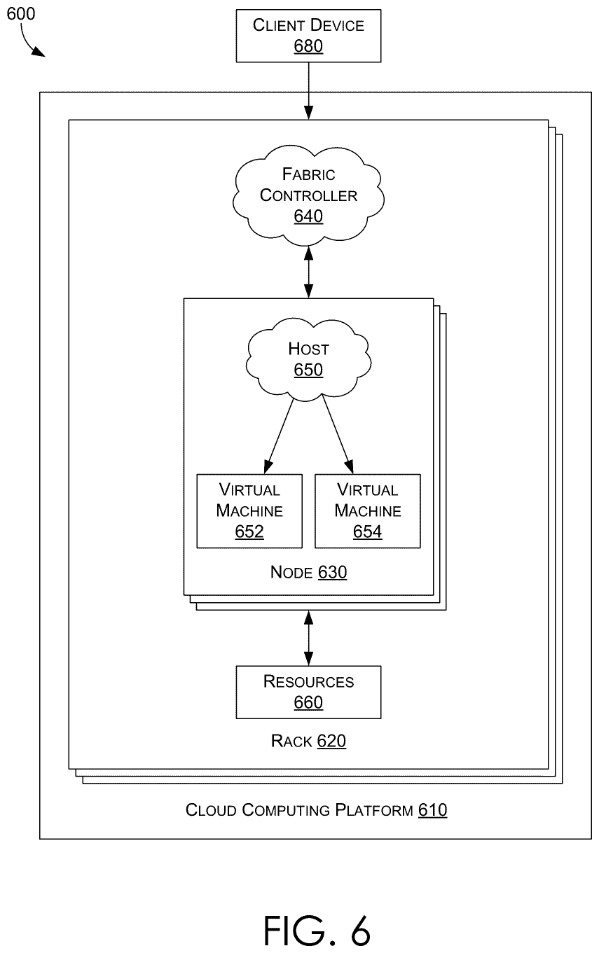

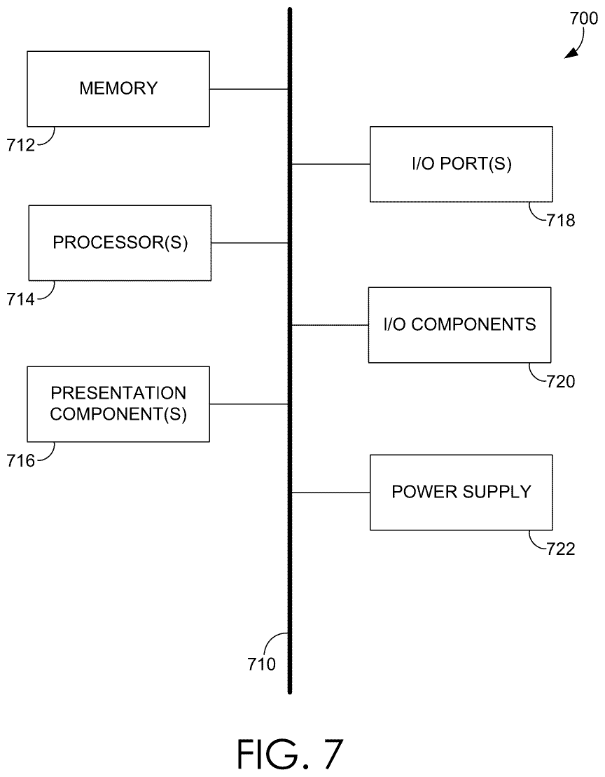

Aspects of the technical solution can be described by way of examples and with reference to FIGS. 2A and 2B. FIG. 2A is a block diagram of an exemplary technical solution environment, based on example environments described with reference to FIGS. 6 and 7 for use in implementing embodiments of the technical solution are shown. Generally the technical solution environment includes a technical solution system suitable for providing the example material processing system 100 in which methods of the present disclosure may be employed. In particular, FIG. 2A shows a high level architecture of the material processing system 100 in accordance with implementations of the present disclosure. Among other engines, managers, generators, selectors, or components not shown (collectively referred to herein as “components”), the technical solution environment of material processing system 100 corresponds to FIGS. 1A and 1B.

With reference to FIG. 2A, FIG. 2A illustrates a material processing system 100 (e.g., mining process system 100X having pit 112, truck 114, crusher 116, source 1 120, sink 1 130). The material processing system 100 further includes material processing input materials 100A, material processing sensors 100B, material processing configuration interface 100C, material processing engine client 110C and material processing engine interface 110D. The material processing system 100 also includes material processing engine 110 having a concentrate grade optimization engine 110A and concentrate grade recommendation interface data 110B.

The material processing system further includes input data 140 having historical data 140A, input materials 140B, and economic data 140D; machine learning engine 150 having flow models (i.e., flow model 150A, flow model 150B, flow model 150C) and causal mathematical model 160; and economic data computation model 180 having revenue data and cost data.

The concentrate grade optimization engine 110A is responsible for providing concentrate grade (i.e., concentrate grade recommendations for a corresponding economic value) using a material processing engine 110 in a material processing system 100. The concentrate grade optimization engine 110A accesses input data input data 140 comprising material processing planning data, economic data associated with a material recovery process. The material processing planning data can include historical data 140A including produced concentrate grades and achieved grades and corresponding recovery and input materials 140B comprising incoming head grades and incoming volumes; and the economic data 140D comprising contract terms, revenue data, and cost data.

The concentrate grade optimization engine 110A analyzes the input data 140 using a grade-recovery relationship machine learning model (e.g., causal mathematical model 160). The causal mathematical model 160 is trained on historical material processing data features (i.e., concentrate grade recommendation features) associated with concentrate grade and recovery of the material recovery process. The causal mathematical model 160 is associated with a plurality of selectivity curves that are equations that define a relationship between concentrate grade and recovery and corresponding economic values of a material of the material recovery process. The causal mathematical model 160 is based on a plurality of flow models (i.e., flow model 150A, flow model 150B, and flow model 150C) that separately model flow in a flotation circuit of corresponding materials associated with the input data and a causal mathematical model that corresponds to historical observation data. The causal mathematical model 160 supports computing concentrate grades that are associated with metallurgical relationships of the materials associated with the plurality of flow models.

The concentrate grade optimization engine 110 generates a concentrate grade that corresponds to an economic value and communicates the concentrate grade and the economic value. The grade-recovery relationship machine learning model comprises causal mathematical model that support predicting a first concentrate grade associated with a first metal and a second concentrate grade associated with a second metal. The economic data is provided via the economic data computation model associated with revenue 180A and cost 180B of the mining recovery process. The economic data computation model supports processing revenue data 180A and cost 180B data associated one or more metals associated with the material recovery process. In this way, the concentrate grade is a quantified value for concentrate grade that corresponds to the economic value, where the economic values is based on a plurality of concentrate grade recommendation features including one or more economic costs.

With reference to FIG. 2B, FIG. 2B illustrates a material processing engine 110 that supports providing concentrate grade recommendation based on a concentrate grade optimization engine. The material processing engine performs a plurality of concentrate grade recommendation operations including: at block 10, access training data comprising material processing data; at block 12, use the training data to train a grade-recovery relationship machine learning model; and at block 14, deploy the grade recovery relationship machine learning model.

The concentrate grade recommendation operations further include: at block 16, access, at a concentrate grade optimization engine, input data comprising material processing planning data, economic data associated with a material recovery process; at block 18, analyze the input data using a grade-recovery relationship machine learning model, the grade-recovery relationship machine learning model is trained on historical material processing data features associated with concentrate grade and recovery the material recovery process; at block 20, based on analyzing the input data using the grade-recovery relationship machine learning model, generate a concentrate grade that corresponds to an economic value; and at block 22, communicate the concentrate grade and the economic value.

The concentrate grade recommendation operations further include: at block 24, communicate input data comprising material processing data, economic data associated with a material recovery process; at block 26, receive a concentrate grade that corresponds to an economic value; and at block 28, cause generation of a visualization associated with the concentrate grade and the economic value.

### Exemplary Methods

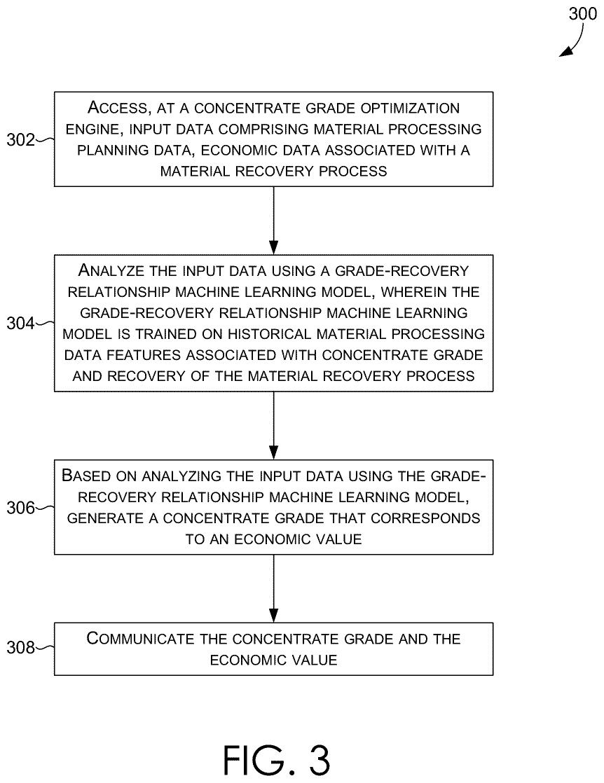

With reference to FIGS. 3, 4 and 5, flow diagrams are provided illustrating methods for providing a concentrate grade recommendation using a concentrate grade optimization engine in material processing engine of a material processing system. The methods may be performed using the material processing system described herein. In embodiments, one or more computer-storage media having computer-executable or computer-useable instructions embodied thereon that, when executed, by one or more processors can cause the one or more processors to perform the methods (e.g., computer-implemented method) in the material processing system (e.g., a computerized system or computing system).

Turning to FIG. 3, a flow diagram is provided that illustrates a method 300 for providing a concentrate grade recommendation using a concentrate grade optimization engine in material processing engine of a material processing system. At block 302, access input data comprising material processing planning data, economic data associated with a material recovery process. At block 304, analyze the input data using a grade-recovery relationship machine learning model, where the grade-recovery relationship machine learning model is trained on historical material processing data features associated with concentrate grade and recovery of the material recovery process. At block 306, based on analyzing the input data using the grade recovery relationship machine learning model, generate a concentrate grade that corresponds to an economic value. At block 308, communicate the concentrate grade and the economic value.

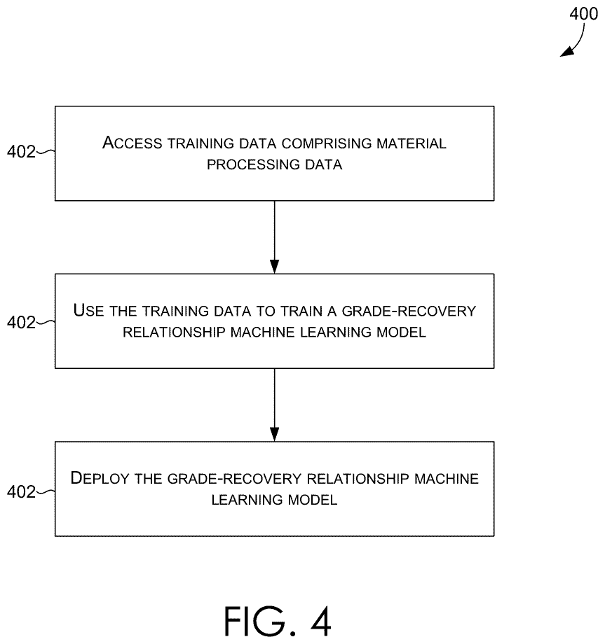

Turning to FIG. 4, a flow diagram is provided that illustrates a method 400 for providing a concentrate grade recommendation using a concentrate grade optimization engine in material processing engine of a material processing system. At block 402, access training data comprising material processing data. At block 404, use the training data to train a grade-recovery relationship machine learning model. At block 406, deploy the grade-recovery relationship machine learning model.

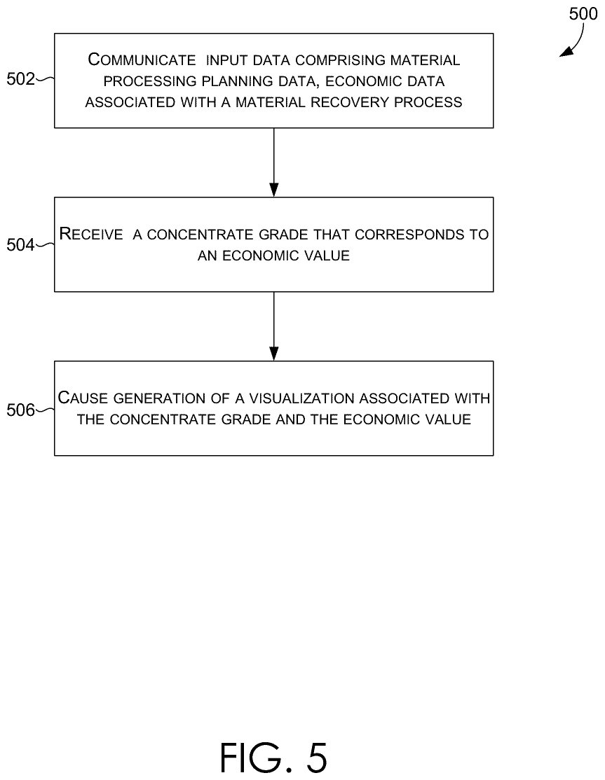

Turning to FIG. 5, a flow diagram is provided that illustrates a method 500 for providing a concentrate grade recommendation using a concentrate grade optimization engine in material processing engine of a material processing system. At block 502, communicate input data comprising material processing planning data and economic data associated with a material recovery process. At block 504, receive a concentrate grade that corresponds to an economic value. At block 506, cause generation of a visualization associated with the concentrate grade and the economic value.

### Additional Support for Detailed Description of the Invention

### Example Distributed Computing System Environment

Referring now to FIG. 6, FIG. 6 illustrates an example distributed computing environment 600 in which implementations of the present disclosure may be employed. In particular, FIG. 6 shows a high level architecture of an example cloud computing platform 610 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 600 that includes cloud computing platform 610, rack 620, and node 630 (e.g., computing devices, processing units, or blades) in rack 620. The technical solution environment can be implemented with cloud computing platform 610 that runs cloud services across different data centers and geographic regions. Cloud computing platform 610 can implement fabric controller 640 component for provisioning and managing resource allocation, deployment, upgrade, and management of cloud services. Typically, cloud computing platform 610 acts to store data or run service applications in a distributed manner. Cloud computing infrastructure 610 in a data center can be configured to host and support operation of endpoints of a particular service application. Cloud computing infrastructure 610 may be a public cloud, a private cloud, or a dedicated cloud.

Node 630 can be provisioned with host 650 (e.g., operating system or runtime environment) running a defined software stack on node 630. Node 630 can also be configured to perform specialized functionality (e.g., compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 630, nodes 630 may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 600 described with reference to FIG. 6, for example, client device 680 can be configured to issue commands to cloud computing platform 610. In embodiments, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include, without limitation, one or more local area networks (LANs) and/or wide area networks (WANs).

### Example Distributed Computing Environment

Having briefly described an overview of embodiments of the present invention, an example operating environment in which embodiments of the present invention may be implemented is described below in order to provide a general context for various aspects of the present invention. Referring initially to FIG. 7 in particular, an example operating environment for implementing embodiments of the present invention is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations comprising:
accessing, at a concentrate grade optimization engine, input data comprising material processing planning data, economic data associated with a material recovery process;
analyzing the input data using a grade-recovery relationship machine learning model, wherein the grade-recovery relationship machine learning model is trained on historical material processing data features associated with concentrate grade and recovery of the material recovery process;
based on analyzing the input data using the grade-recovery relationship machine learning model, generating a concentrate grade that corresponds to an economic value; and
communicating the concentrate grade and the economic value.

2. The system of claim 1, wherein the material processing planning data comprises historical data including produced concentrate grades and achieved grades and corresponding recovery, and input materials comprising incoming head grades and incoming volumes; and the economic data comprising contract terms, revenue data, and cost data.

3. The system of claim 1, wherein the grade-recovery relationship machine learning model is associated with a plurality of selectivity curves that are equations that define a relationship between concentrate grade and recovery and corresponding economic values of a material of the material recovery process.

4. The system of claim 1, wherein the grade-recovery relationship machine learning model is based on a plurality of flow models that separately model flow in a flotation circuit of corresponding materials associated with the input data and a causal mathematical model that corresponds to historical observation data,
wherein a causal mathematical model supports computing concentrate grades that are associated with metallurgical relationships of the materials associated with the plurality of flow models.

5. The system of claim 1, wherein the grade-recovery relationship machine learning model comprises causal mathematical model that support predicting a first concentrate grade associated with a first metal and a second concentrate grade associated with a second metal.

6. The system of claim 1, wherein the economic data is associated with an economic data computation model that supports providing revenue data and cost data associated one or more metals associated with the material recovery process.

7. The system of claim 1, wherein the concentrate grade is a quantified value for concentrate grade that corresponds to the economic value, wherein the economic values is based on a plurality of concentrate grade recommendation features including one or more economic costs.

8. One or more computer-storage media having computer-executable instructions embodied thereon that, when executed by a computing system having a processor and memory, cause the processor to:
access, at a concentrate grade optimization engine, input data comprising material processing planning data, economic data associated with a material recovery process;
analyze the input data using a grade-recovery relationship machine learning model, wherein the grade-recovery relationship machine learning model is trained on historical material processing data features associated with concentrate grade and recovery of the material recovery process;
based on analyzing the input data using the grade-recovery relationship machine learning model, generating a concentrate grade that corresponds to an economic value; and
communicating the concentrate grade and the economic value.

9. The media of claim 8, wherein the material processing planning data comprises historical data including produced concentrate grades and achieved grades and corresponding recovery, and input materials comprising incoming head grades and incoming volumes; and the economic data comprising contract terms, revenue data, and cost data.

10. The media of claim 8, wherein the grade-recovery relationship machine learning model is associated with a plurality of selectivity curves that are equations that define a relationship between concentrate grade and recovery and corresponding economic values of a material of the material recovery process.

11. The media of claim 8, wherein the grade-recovery relationship machine learning model is based on a plurality of flow models that separately model flow in a flotation circuit of corresponding materials associated with the input data and a causal mathematical model that corresponds to historical observation data, wherein the causal mathematical model supports computing concentrate grades that are associated with metallurgical relationships of the materials associated with the plurality of flow models.

12. The media of claim 8, wherein the grade-recovery relationship machine learning model comprises a causal mathematical model that support predicting a first concentrate grade associated with a first metal and a second concentrate grade associated with a second metal.

13. The media of claim 8, wherein the economic data is associated with an economic data computation model that supports providing revenue data and cost data associated one or more metals associated with the material recovery process.

14. The media of claim 8, wherein the concentrate grade is a quantified value for concentrate grade that corresponds to the economic value, wherein the economic values is based on a plurality of concentrate grade recommendation features including one or more economic costs.

15. A computer-implemented method, the method comprising:
accessing, at a concentrate grade optimization engine, input data comprising material processing planning data, economic data associated with a material recovery process;
analyzing the input data using a grade-recovery relationship machine learning model, wherein the grade-recovery relationship machine learning model is trained on historical material processing data features associated with concentrate grade and recovery of the material recovery process;
based on analyzing the input data using the grade-recovery relationship machine learning model, generating a concentrate grade that corresponds to an economic value; and
communicating the concentrate grade and the economic value.

16. The method of claim 15, wherein the material processing planning data comprises historical data including produced concentrate grades and achieved grades and corresponding recovery, and input materials comprising incoming head grades and incoming volumes; and the economic data comprising contract terms, revenue data, and cost data.

17. The method of claim 15, wherein the grade-recovery relationship machine learning model is associated with a plurality of selectivity curves that are equations that define a relationship between concentrate grade and recovery and corresponding economic values of a material of the material recovery process.

18. The method of claim 15, wherein the grade-recovery relationship machine learning model is based on a plurality of flow models that separately model flow in a flotation circuit of corresponding materials associated with the input data and a causal mathematical model that corresponds to historical observation data,
wherein the causal mathematical model supports computing concentrate grades that are associated with metallurgical relationships of the materials associated with the plurality of flow models.

19. The method of claim 15, wherein the grade-recovery relationship machine learning model comprises a causal mathematical model that support predicting a first concentrate grade associated with a first metal and a second concentrate grade associated with a second metal.

20. The method of claim 15, wherein the economic data is associated with an economic data computation model that supports providing revenue data and cost data associated one or more metals associated with the material recovery process,
wherein the concentrate grade is a quantified value for concentrate grade that corresponds to the economic value, wherein the economic values is based on a plurality of concentrate grade recommendation features including one or more economic costs.
